(19) United States
(12) Patent Application Publication
(10) Pub. No.: US 2011/0148006 A1
(43) Pub. Date: Jun. 23, 2011

(54) FIBRE-PRODUCTION DEVICE AND FIBRE-PRODUCTION METHOD

(75) Inventors: Katsuhiro Nagayama, Tokyo (JP); Kunio Miyazawa, Tokyo (JP); Shigeyuki Nakano, Hyogo (JP)

(73) Assignees: JFE CHEMICAL CORPORATION, Tokyo (JP); HYOGO PREFECTURE, Hyogo (JP)

(21) Appl. No.: 13/058,747

(22) PCT Filed: Aug. 7, 2009
(86) PCT No.: PCT/JP2009/064324

§ 371 Date: Mar. 14, 2011

(30) Foreign Application Priority Data
Aug. 11, 2008 (JP) 2008-207196
Apr. 27, 2009 (JP) 2009-107654

(51) Int. Cl. B29C 47/88; B29C 47/92

(52) U.S. Cl. 264/465; 425/144

(57) ABSTRACT

A fiber-producing apparatus includes a storage tank for storing a melt of a source material, an electric storage tank heater, a non-contact thermometer for the melt, a temperature control section which between the electric heater and its power supply, which controls the electric heater based on measurement results obtained from the non-contact thermometer to adjust the temperature of the melt, a nozzle for ejecting the melt in the storage tank, a collector for collecting a fiber, a voltage generator for electrifying the melt, and an insulating transformer disposed between the temperature control section and the electric heater. Since a closed circuit is formed by the electric heater, the electric heater power supply, the temperature control section, and the insulating transformer disposed therebetween, no high-voltage current flows into the electric heater power supply or the temperature control section. This allows stable spinning to be readily performed without breaking the apparatus.

### TECHNICAL FIELD

The present invention relates to a fiber-producing apparatus and fiber-producing method for producing a fiber by an electrospinnng process.

### BACKGROUND ART

In recent years, demands for microfibers with sub-micrometer diameters have been increasing in the expectation that the submicrofibers would be applicable to electronics such as sensors and electron guns for electric wires and illuminators on semiconductor substrates, environment-responsive products such as high-performance filters, medical products such as wound protectors and scaffolds for tissue engineering. Therefore, the importance of electrospinning techniques has been reconfirmed and has been attracting attention.

An apparatus for producing a fiber by an electrospinning process has a relatively simple structure, in which a fluid is formed into fibers by applying a voltage between a fluid supply section (which usually includes a tank and a nozzle) and a fiber-receiving section. The electrospinning process is capable of directly forming a fluid such as a polymer solution or suspension into a fiber with sub-micrometer diameters without using any conjugate spinning process or blend spinning process and is useful in obtaining a single-nanometer diameter fiber. In usual, a fluid is fed from a fluid storage tank like, a syringe to a nozzle, a capillary, or the like with gas pressure or a metering pump and is then sprayed onto a fiber, receiving section, which is a grounded counter electrode, in the form of a fiber by applying a high voltage to the fluid, the nozzle, the capillary, or the like, which is conductive.

Patent Literature 1 discloses an apparatus for producing a submicrofiber by an electrospinning process. Patent Literature 1 describes that the type of a fluid used is not particularly limited and it is important for the fluid to have spinnability. The most preferable viscosity of the fluid is 100 Pa·s to 1000 Pa·s. Examples of the fluid include various polymer melts, polymer solutions, suspensions, inorganic sols, and mixtures thereof. Common polymeric materials (polymers) and pitch materials such as coal tar Pitch and petroleum pitch can be used. However, no specific process for preparing a melt of a polymeric material or a pitch material is disclosed in Patent Literature 1.

### Citation List

### Patent Literature

PTL 1: Japanese Unexamined Patent Application Publication No. 2006-152479

### SUMMARY OF INVENTION

### Technical Problem

Among techniques for obtaining melts of polymeric materials or pitch materials, there: is a technique for heating a tank storing a polymeric material or a pitch material, with an electric heater. The technique is probably excellent in temperature controllability, scale-up capability, and cost efficiency. In the case of spinning a polymeric material with a high melting point or a pitch material with a high softening point, a tank and a nozzle need to be heated because heat insulation alone allows the temperature of the polymeric material or the pitch material to decrease and allows the viscosity thereof to increase and therefore it is difficult to spin the polymeric material, or the pitch material. This is particularly apparent to high-softening point pitch because the viscosity thereof is heavily temperature-dependent.

The technique for heating the tank with the electric heater, however, has a problem below. That is, a high-voltage current generated from a voltage-generating section for applying a high voltage to a fluid or the nozzle flows into the electric heater, which is adjacent to the voltage-generating section, and may further now back to a power supply of the electric heater. Such a current leakage causes: difficulty in stable spinning because a breaker connected to an outlet, a power supply, or the like is tripped and/or the control of temperature cannot be appropriately performed with the electric heater.

The following technique may be used to cope with the current leakage: a technique in which a ceramic member for preventing the current leakage is provided between the tank and the electric heater. The ceramic member is likely to be broken by the influence of high temperature or high voltage. Hot air or a heat medium may be used for heating instead of the electric heater. However, the use of hot air or the heat medium, for a fiber-producing apparatus causes an increase in size and therefore is industrially unsuitable.

In the case of using a temperature controller to precisely control the temperature of the tank or the nozzle, there is a problem in that a high-voltage current generated from the voltage-generating section flows into the temperature controller through the electric heater or a thermocouple to break a board in the temperature controller. In particular, the application of a high voltage of more than 3.0 kV causes a problem that a high-voltage current flows into the temperature controller to break the board: in the temperature controller when a human or tool serving as an earth approaches the temperature controller during the production of fibers.

It is an object of the present invention to provide a fiber-producing apparatus and fiber-producing method which are capable of solving the problems of the conventional techniques and which are capable of readily performing stable spinning, the apparatus being unlikely to be broken.

### Solution to Problem

In order to solve the above problems, the present invention is configured as described below. A fiber-producing apparatus, according to the present invention, for producing a fiber from a source material such as a polymeric material or a pitch material by an electrospinning process includes a storage section for storing a melt of the source material, an electric heater for heating the storage section to keep the source material molten, a temperature measurement section for measuring the temperature of the melt of the source material in a non-contact way, a temperature control section which is disposed between the electric heater and an electric heater power supply and which controls the electric heater on the basis of measurement results obtained from the temperature measurement section to adjust the temperature of the melt of the source material, a nozzle which communicates with the storage tank and from which the melt of the source material is ejected, a collector for collecting a fiber formed by ejecting the melt, of the source material from the nozzle, a voltage-generating section for applying a voltage between the nozzle and the collector to electrify the melt of the source material, and an insulating transformer disposed between the temperature control section and the electric heater.

A fiber-producing method, according to the present invention, for producing a fiber by an electrospinning process in which the fiber is formed by ejecting a melt of an electrified source material from a nozzle and is then collected with a collector includes heating the melt of the source material using an electric heater connected to a power supply through an insulating transformer to keep the source material molten and also includes adjusting the temperature of the melt of the source material in such a manner that the electric heater is controlled with a temperature control section disposed between the electric heater and the power supply on the basis of results obtained by measuring the temperature of the melt of the source material in a non-contact way.

### Advantageous Effects of Invention

A fiber-producing apparatus and fiber-producing method according to the present invention are capable of readily performing stable spinning and the apparatus is unlikely to be broken.

### BRIEF DESCRIPTION OF DRAWINGS

FIG. 1 is a schematic view showing the configuration of a fiber-producing apparatus for producing a fiber by an electrospinning process.

FIG. 2 is a sectional view of an exemplary nozzle.

### DESCRIPTION OF EMBODIMENTS

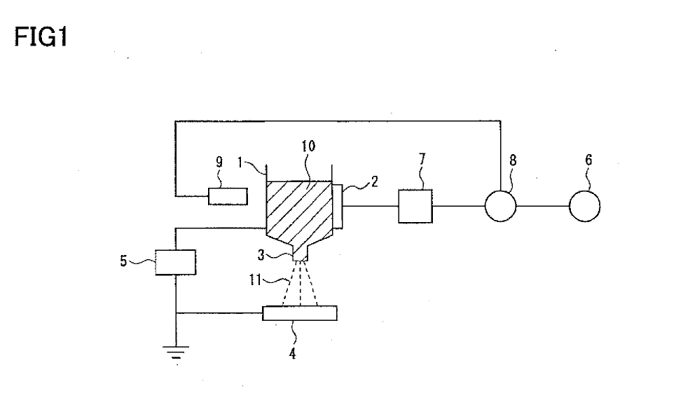

A fiber-producing apparatus and fiber-producing method according to the present invention will now be described in detail with reference to the accompanying drawings. FIG. 1 is a schematic view showing the configuration of the fiber-producing apparatus, which is used to produce a fiber by an electrospinning process.

The fiber-producing apparatus includes a storage tank for 1 storing a melt 10 of a source material (a polymeric material or a pitch material), an electric heater 2 for heating the storage tank 1 to keep the source material molten, a non-contact thermometer 9 for measuring the temperature of the melt 10 of the source material in a non-contact way, a temperature control section 8 which is disposed between the electric heater 2 and an electric heater power supply 6 and which controls the electric heater 2 on the basis of measurement results obtained from the non-contact thermometer 9 to adjust the temperature of the melt 10 of the source material, a nozzle 3 which is attached to the storage tank 1 and, from which the melt 10 of the source material in the storage tank 1 is ejected, a collector 4 for collecting a fiber 11 made of the source material, a voltage generator 5 for applying a voltage between the nozzle 3 and the collector 4 to electrify the melt 10 of the source material, and an insulating transformer 7 disposed between the temperature control section 8 and the electric heater 2.

The storage tank 1, the nozzle 3, and the melt 10 are positively electrified by the application of a voltage thereto and the collector 4 is grounded. Therefore, after the electrified melt 10 is fed from the storage tank 1 to the nozzle 3 and is then ejected from the nozzle 3, the melt 10 is attracted by the collector 4 in a fibrous form, whereby the fiber 11 is collected with the collector 4, the fiber 11 being very fine and having a diameter on the order of a micrometer or a nanometer. The collector 4 may be negatively electrified, using another voltage generator capable of negatively electrifying the collector 4.

The diameter, length, morphology, and/or surface properties of the fiber 11 can be controlled by adjusting properties, such as viscosity, electrical conductivity, elasticity, and surface tension, of the melt 10; production conditions such as an application voltage, the feed rate of the melt 10, and the distance between the nozzle 3 and the collector 4; and/or environmental conditions such as ambient temperature, humidity, and pressure.

The fiber-producing apparatus is further described in detail. The number of storage tanks used may be one or more. A solid polymeric material or pitch material may be melted in the storage tank 1 having the nozzle 3 attached thereto. A continuous spinning apparatus may include another storage tank in which the solid polymeric material or pitch material is melted and stored. The melt 10 may be fed from this storage tank to the storage tank 1, which has the nozzle 3 attached thereto, with a gear pump or the like.

A material for forming the storage tank 1 can be arbitrarily selected depending on properties of the melt 10 and is preferably stainless steel or glass, which is inexpensive. When the melt is highly corrosive, the storage tank 1 is preferably made of as precious metal such as platinum or nickel. Alternatively, the storage tank 1 may be made of a ceramic. The storage tank 1 need not has a single-piece structure and preferably has a decomposable structure composed of a plurality of members in consideration of maintenance. In this case, the melt 10 is preferably prevented, from leaking due to an internal pressure and packings made of aluminum, PTFE, or the like are provided between the members.

The nozzle 3 is described below. The nozzle 3 is a section for ejecting the melt 10 from the storage tank 1 toward the collector 4. The nozzle 3 may be used alone or in combination with one or more nozzles. In view of an increase in production efficiency, a plurality of nozzles are preferably used. The Shape of the nozzle 3 is preferably convex in the direction in which the melt 10 is ejected. This allows the melt 10 to travel straight toward the collector 4, resulting in stable spinning.

When the shape of the nozzle 3 is flat or concave, an equipotential surface near a disengaging portion of the melt 10 is flat and perpendicular to the direction in which the melt 10 is ejected; hence, the electrified melt 10 may lose bearings thereof. Therefore, the traveling direction of the melt 10 is extremely difficult to control. This may deteriorate spinning stability.

Examples of the shape of the nozzle 3 include needle shapes, bar shapes, conical, shapes, polygonal pyramid shapes (such as triangular pyramid shapes and quadrangular pyramid shapes), dome shapes, semi-cylindrical shapes, and combinations of these shapes. The tip of the nozzle 3 need not be circular in cross section. The tip thereof is not particularly limited in cross-sectional shape and may have a triangular shape such as an equilateral triangular shape or an isosceles triangular shape), a quadrangular shape (such as a square shape or a rectangular shape), a polygonal shape, a Y shape, a C shape, a hollow shape, or a flat shape in cross section. The melt 10 may be fed through the nozzle 3 by capillary action or may be guided to the tip of the nozzle 3 by the pneumatic pressure applied to the storage tank 1, the surface tension of a bottom portion thereof, gravity, or draw tension.

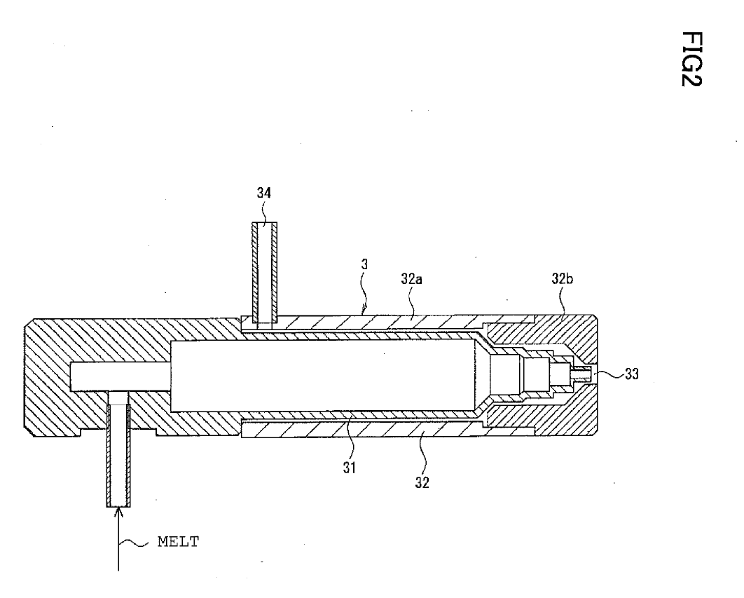

The nozzle 3 may be one shown in FIG. 2. With reference to FIG. 2, the nozzle 3 includes a first nozzle portion 31 for ejecting the melt 10, which is stored in the storage tank 1, in the form of a fine filament and a second nozzle portion 32 which is disposed outside the first nozzle portion 31 and from which the melt 10 ejected from the first nozzle portion 31 is pneumatically ejected with a pressuring as such as nitrogen gas in the form of a fine filament.

The second nozzle portion 32 includes a cylindrical barrel 32a disposed outside the first nozzle portion 31 and a nozzle guide 32b having a nozzle opening 33 which is located on the top side of the barrel 32a and which has a diameter of, for example, about 0.5 mm. The barrel 32a includes a pressuring gas supply port 34 for supplying the pressuring gas, such as nitrogen gas, to the second nozzle portion 32. The barrel 32a is made of a highly heat conductive material (for example, stainless steel). An electric heater (not shown) is wound on the outer surface of barrel 32a for the purpose of keeping the melt 10, supplied from the storage tank 1 to the first nozzle portion 31, molten.

Examples of the pressuring gas, which is introduced into the Second nozzle portion 32 of the nozzle 3, include air, helium gas, argon gas, and nitrogen gas. However, the use of air is preferably avoided because the fiber is rapidly oxidized at an elevated temperature higher than 300° C. to generate heat or ignite Preferred examples of the pressuring gas include inert gases, such as helium, nitrogen, and argon, oxidizing no fiber. When the temperature of the pressuring gas is extremely low or high, the melt 10 is possibly solidified or decomposed, respectively.

The collector 4 is described below. The collector 4 is a section for collecting the fiber 11 elected from the nozzle 3. The collector 4 may include a plurality of units or may be movable like a belt conveyer. A portion of the fiber 11 that leaves the nozzle 3 to substantially first contact the collector 4 is contained in the collector 4. A voltage is applied between the collector 4 and the nozzle 3 or the melt 10, whereby the fiber 11 is collected with the collector 4.

A technique for voltage application is not particularly limited. The collector 4 may be a positive or negative electrode. In view of the simplicity and safety of the fiber-producing apparatus, it is preferred that one collector 4 be grounded and the nozzle 3 be used as a positive electrode. The voltage applied between the nozzle 3 end the collector 4 is preferably 500 V to 100 kV and is appropriately set depending on the distance therebetween. When the voltage applied therebetween is less than 500 V, the melt 10 is unlikely to leave the nozzle 3. When the voltage applied therebetween is greater than 100 kV, electric discharge possibly occurs therebetween.

In the fiber-producing apparatus, the temperature of the melt 10 is adjusted in such a manner that the electric heater 2 is controlled with the temperature control section 8 on the basis of measurement results obtained from the non contact thermometer 9. Since the electric heater 2 is close to the storage tank 1 and the nozzle 3, to which a high voltage is applied, a high-voltage current flows from the voltage generator 5 into the electric heater 2 and may further flow back to the power supply 8 of the electric heater 2 or the temperature control section 8. Such a current leakage causes problems such as failures in the electric heater power supply 6 and/or the temperature control section 8 or prevents the temperature of the melt 10 from being appropriately controlled with the electric heater 2. This may cause: difficulty in stable spinning.

The fiber-producing apparatus of this embodiment has a closed circuit formed by the electric heater 2, the electric heater power supply 6, the temperature: control section 8, and the insulating transformer 7 disposed therebetween. Therefore, no high-voltage current flows into the electric heater power supply 6 or the temperature control section 8, which is located, on the primary side of the insulating transformer 7. This prevents problems such as failures from occurring in the electric heater power supply 6 or the temperature control section 8 (for example, a board). The temperature of the melt 10 can be appropriately controlled with the electric heater 2 and therefore the melt 10 can be stably kept at a desired temperature (that is, the viscosity of the melt 10 is kept constant). This enables stable spinning.

If the melt 10 of the source material is measured for temperature with, for example, a thermocouple in contact with the electric heater 2, the storage tank 1, or another member, the high-voltage: current may flow into the temperature control section 8 through the thermocouple to break the temperature control section 8. However, in the fiber-producing apparatus of this embodiment, the melt 10 of the source material is measured for temperature with a non-contact temperature measuring instrument such as an infrared radiometric temperature sensor; hence, there is no possibility that the high-voltage current flows into the temperature control section 8 through the temperature measuring instrument.

The electric beater 2 is excellent in temperature controllability and efficiency and therefore is preferred as a heat source for heating the source material in the fiber-producing apparatus. The electric neater 2 is not particularly limited in type and may be an ordinary one is sufficient for the electric heater 2 to increase the temperature to about 500° C. The dielectric strength of the electric heater 2 is preferably greater than the voltage applied thereto. The electric heater 2 may be provided in the storage tank 1 (inside heating) and is preferably attached to the outside of the storage tank 1 (inside heating) an view of avoiding the complexity of the apparatus.

The melt 10 preferably has a viscosity of 10 poise (1 Pa·s) to 10000 poise (1000 Pa·s). The melt 10 is heated to an appropriate temperature so as to have such a viscosity.

The type of the source material is not particularly limited. Examples of the source material include polymeric materials such as polyethylene terephthalate (PET), polypropylene terephthalate (PPT), polybutylene terephthalate (PBT), polvvinvaidene fluoride (PVDF), polyacrylonitrile (PAN), polyacrylic acid, polymethyl methacrylate (PMMA), polystyrene (PS), polycarbonate, polymethylpentene (PMP), polyvinyl chloride (PVC), polyethylene (PE), polypropylene (PP), polyamides (including polyamide 6, polyamide 66, polyamide 610, polyamide 12, polyamide 46, and polyamide 9T) polyurethanes, aramids, polyimides (PIs), polybenzimidazoles (PBIs), polybenzoxazoles (PBOs), polyvinyl alcohol (PVA), cellulose, celluose acetate, cellulose acetate butyrate, polyvinylpyrrolidone (PVP), polyethyleneimides (PEIs), polyoxyethylene (POM), polyethylene oxide (PEO), poly(ethylene Succinate), poly (ethylene sulfide), poly (propylene oxide), poly (vinyl acetate), polyaniline, poly(ethylene terephthalate), poly(hydroxybutyric acid), poly(ethylene oxide), polylactic acid (PLA), polyglycolic acid (PGA), polyethylene glycol (PEG), ploycaprolactone, polypeptides, proteins, collagen, copolymers of these materials, and mixtures of these materials and pitch materials such as coal tar pitch and petroleum pitch. The polymeric materials and the pitch materials can be used in combination with organic or inorganic powders, whiskers, or the like.

The present invention is further described below in detail, with reference to examples.

### Example 1

Spinning was performed using a fiber-producing apparatus having a configuration shown in FIG. 1, A source material used was pitch, prepared from coal tar, having a softening point of 80° C.

The pitch was filled into a storage tank (a volume of 10 mL) made of stainless steel. The storage tank had a 28G nozzle (an inner diameter of 0.16 mm), made of stainless steel, attached to a lower portion of the storage tank and an electric heater wound on the outer surface of the storage tank. A power supply for the electric heater was a 100-V outlet. An insulating transformer was placed between the electric heater and the outlet. The outlet was connected to an input port of the insulating transformer and the electric heater was connected to an output port thereof. A 100-V current output from the output port was used to power the electric heater.

A temperature controller, receiving a signal from a temperature sensor, for controlling the electric heater was placed between the insulating transformer and the outlet. The temperature sensor was a type of infrared radiometric temperature sensor and was used to measure the temperature of the outer surface (a portion not, covered with the electric heater) of the storage tank. The temperature of the pitch in the storage tank was controlled to 180° C. using the predetermined relationship between the temperature of the outer surface of the storage tank and the temperature of the pitch in the storage. tank.

A voltage of 35 kV generated. from a voltage generator was applied to the storage tank. An earth electrode (collector) was placed at a position which was 100 mm directly under the nozzle. Spinning was performed in such a manner that the pitch was ejected from the nozzle by applying a nitrogen pressure of 0.7 MPa to the storage tank, which was sealed. The spinning of the pitch was successfully performed and therefore fibers with a diameter of about 1 to 5 μm and fibers with a diameter of several hundreds of nanometers were obtained. During spinning, no high-voltage current leaked into the temperature controller or the outlet.

After the pitch fibers trapped with the collector were collected with a tool made of bamboo, spinning was performed again. This enabled continuous spinning without any problem.

### Comparative Example 1

Spinning was attempted in substantially the same manner as that described in EXAMPLE 1 except that no insulating transformer was placed between the 100-V outlet and the electric heater. However, spinning could not be stably performed because a high-voltage current leaked into the electric heater to trip a breaker connected to the outlet and therefore the temperature of the pitch in the storage tank was reduced. The current leakage damaged a board in the temperature controller.

### Example 2

Spinning was performed using a fiber-producing apparatus having a configuration shown in FIG. 1. A source material used was mesophase pitch, prepared from coal tar, having a softening point of 280° C.

The mesophase pitch was filled into a storage tank (a volume of 10 mL) made of stainless steel. The storage tank had a nozzle attached to a lower portion of the storage tank as shown in FIG. 2 and an electric heater wound on the outer surface of the storage tank. A power supply for the electric heater was a 100-V outlet. An insulating transformer was placed between the electric heater and the outlet. The outlet was connected to an input port of the insulating transformer and the electric heater was connected to an output port thereof. A 100-V Current output from the output port was used to power the electric, heater. A portion (an end portion) for ejecting the mesophase pitch was a 27G nozzle which was made of stainless steel, which had an inner diameter of 0.20 mm and an outer diameter of 0.42 mm, and which had a nozzle hole 33 with a diameter of 0.50 mm.

A temperature controller, receiving a signal from a temperature sensor, for controlling the electric heater was placed between the insulating transformer and the outlet. The temperature sensor was a type of infrared radiometric temperature sensor and was used to measure the temperature of the outer surface (a portion not covered with the electric heater) of the storage tank. The temperature of the mesophase pitch in the storage tank was controlled to 350° C. using the predetermined relationship between the temperature of the outer surface of the storage tank and the temperature of the mesophase pitch in the storage tank.

A voltage of 25 kV generated from a voltage generator was applied to the storage tank. An earth electrode collector) was placed at a position which was 120 mm directly under the nozzle. Spinning as performed in such a manner that the mesophase pitch was elected from the nozzle, which was kept at 350° C., by applying a nitrogen pressure of 0.5 MPa to the storage tank, which was sealed. In this operation, nitrogen gas, preheated to 350° C., serving as a pressuring gas was fed through the nozzle such that the linear velocity of the nitrogen gas flowing through a gap (a gap between a first nozzle portion and a second nozzle portion) located at the tip of the nozzle was 100 m/s.

The spinning of the mesophase pitch was successfully performed and therefore a submicrofiber was obtained. During spinning, no high-voltage current leaked into the temperature controller or the outlet.

The obtained submicrofiber was infusibilized, was carbonized, and was then graphitized at 270° C., whereby a carbon fiber with a relatively uniform diameter of about GOO nm to 800 nm was obtained.

### Example 3

Spinning and graphitization were performed in substantially the same mariner as that described in EXAMPLE 2 except that no nitrogen gas preheated to 350° C. was fed. As a result, a carbon fiber with a diameter of about 3 μm to 5 μm was obtained.

### INDUSTRIAL APPLICABILITY

A fiber-producing apparatus and fiber-producing method according to the present invention are capable of readily performing stable spinning and the apparatus is unlikely to be broken. Therefore, the apparatus and the method are capable of greatly contributing to industries.

1. A fiber-producing apparatus for producing a fiber from a source material such as a polymeric material or a pitch material by an electrospinning process, the fiber-producing apparatus comprising:
a storage section for storing a melt of the source material;
an electric heater for heating the storage section to keep the source material molten;
a temperature measurement section for measuring the temperature of the melt of the source material in a non-contact way;
a temperature control section which is disposed between the electric heater and an electric heater power supply and which controls the electric heater on the basis of measurement results obtained from the temperature measurement section to adjust the temperature of the melt of the source material;
a nozzle which communicates with the storage tank and from which the melt of the source material is ejected;
a collector for collecting a fiber formed by ejecting the melt of the source material from the nozzle;
a voltage-generating section for applying a voltage between the nozzle and the collector to electrify the melt of the source material; and
an insulating transformer disposed between the temperature control section and the electric heater.

2. A fiber-producing method for producing a fiber by an electrospinning process in which the fiber is formed by ejecting a melt of an electrified source material from a nozzle and is then collected with a collector, the fiber-producing method comprising heating the melt of the source material using an electric heater connected to a power supply through an insulating transformer to keep the source material molten and adjusting the temperature of the melt of the source material in such a manner that the electric heater is controlled with a temperature control section disposed between the electric heater and the power supply on the basis of results obtained by measuring the temperature of the melt of the source material in a non-contact way.
